(19) United States
(12) Patent Application Publication
(10) Pub. No.: US 2023/0206118 A1
(43) Pub. Date: Jun. 29, 2023

(54) MODEL LEARNING APPARATUS, METHOD AND PROGRAM FOR THE SAME

(71) Applicant: NIPPON TELEGRAPH AND TELEPHONE CORPORATION, Tokyo (JP)

(72) Inventors: Hosana KAMIYAMA, Tokyo (JP); Yuki KITAGISHI, Tokyo (JP); Atsushi ANDO, Tokyo (JP); Ryo MASUMURA, Tokyo (JP); Takeshi MORI, Tokyo (JP); Satoshi KOBASHIKAWA, Tokyo (JP)

(73) Assignee: NIPPON TELEGRAPH AND TELEPHONE CORPORATION, (omitted)

(21) Appl. No.: 17/912,493

(22) PCT Filed: Mar. 19, 2020
(86) PCT No.: PCT/JP2020/012231

§ 371 Date: Sep. 17, 2022

(51) Int. Cl. G06N 20/00

(52) U.S. Cl. CPC G06N 20/00

(57) ABSTRACT

Provided is a model learning technology to learn a model in consideration of a difference in label assignment accuracy between experts and non-experts. A model learning apparatus includes: an expert probability label acquisition unit that calculates a probability h_{j,c} that a true label with respect to data corresponding to learning feature amount data j is a label c using a set of data to which evaluators of experts have assigned labels; a probability label acquisition unit that calculates a probability h_{j,c} that the true label with respect to the data corresponding to the learning feature amount data j is the label c using a set of data to which evaluators of experts or non-experts have assigned labels and the probability h_{j,c} calculated by the expert probability label acquisition unit; and a learning unit that regards feature amount data as input using the probability h_{j,c} calculated by the probability label acquisition unit and learning feature amount data j corresponding to the probability h_{j,c} calculated by the probability label acquisition unit and learns a model for outputting a label.

### TECHNICAL FIELD

The present invention relates to a technology to estimate labels such as impression labels.

### BACKGROUND ART

In conversation skill tests for examining the likabilities of telephone voice (NPL 1), pronunciation proficiency and fluency in foreign languages (NPL 2), or the like as one of the items of the skill tests, quantitative impression values are assigned to voice. As an impression evaluation, a five-grade evaluation in which impressions are evaluated on a scale of a “good” impression to a “bad” impression, a five-grade evaluation in which likabilities are evaluated on a scale of a “high” likability to a “low” likability, a five-grade evaluation in which naturalness is evaluated on a scale of “high” naturalness to “low” naturalness, or the like is, for example, used.

Presently, the experts of respective skills evaluate the voice impressions and determine acceptability. However, if an automatic evaluation is made possible, the evaluation can be used for the cutoff points of tests or the like or can be used as a reference value for experts unaccustomed to an evaluation (for example, fledgling evaluators). Therefore, technologies to automatically estimate voice impressions have been demanded.

In order to realize the automatic data estimation of impressions using machine learning, a machine learning model may only be learned from impression value data and the feature amounts of the data. However, since persons have different feeling criteria or are unaccustomed to the assignment of impressions, impression values are sometimes different between the persons even if the data is the same. In order to make it possible to estimate average impressions, there is a need to assign impression values to one data by multiple persons and use an average of the impression values. In order to make it possible to stably estimate average impression values, impression values may only be assigned by multiple persons to a greater extent. For example, in impression data generated in NPL 3, impression values are assigned to one voice data by 10 persons.

### CITATION LIST

### Non Patent Literature

[NPL 1] F. Burkhardt, B. Schuller, B. Weiss and F. Weninger, “Would You Buy a Car From Me?” On the Likability of Telephone Voices″, In Proc. INTERSPEECH, pp.1557-1560, 2011.
[NPL 2] Kei Ohta and Seiichi Nakagawa, “A statistical method of evaluating pronunciation proficiency for Japanese words”, INTERSPEECH2005, pp.2233-2236.
[NPL 3] Takayuki Kagomiya et al., “Summary of Impression Evaluation Data”, [online], [Searched on Mar. 5, 2020], Internet < URL: http://pj.ninjal.ac.jp/corpus_center/csj/manu-f/impression.pdf>

### SUMMARY OF THE INVENTION

### Technical Problem

Practically, it is difficult to assign a large amount of impression values to one data due to the constraint of the number of persons. In view of this, some data is dispersed so that multiple persons assign impression values (hereinafter, persons who assign impression values will also be called “evaluators”). Therefore, the number of persons who assign impression values to one data is about one or two at most. In this situation, experts capable of correctly determining impressions are needed to assign impression labels to a greater amount of data in order to realize the impression estimation of voice with good quality. However, since the assignment of labels by experts is costly, it is difficult to assign impression labels to all data.

The present invention has an object of providing: a model learning apparatus in which experts do not assign labels to all data but assign the labels only to some of the data while non-experts assign labels to the remaining data and which learns a model in consideration of a difference in label assignment accuracy between the experts and the non-experts; a method thereof; and a program. Here, it is assumed that the non-experts are evaluators having lower label assignment accuracy than the experts. Hereinafter, labels assigned by non-experts will also be called non-expert labels, and labels assigned by experts will also be called expert labels.

### Means for Solving the Problem

In order to solve the above problem, an aspect of the present invention provides a model learning apparatus in which learning label data includes, with respect to data numbers i (i = 1, ..., L), data numbers j∈{1, ..., J} showing data numbers y(i,0) of learning feature amount data, evaluator numbers k∈{1, ..., K} showing numbers y(i,1) of evaluators who have assigned labels to data corresponding to the learning feature amount data, labels c∈{1, ..., C} showing labels y(i,2) assigned to the data corresponding to the learning feature amount data, and expert flags f representing flags y(i,3) showing whether the evaluators are experts who assign labels to the data corresponding to the learning feature amount data, the model learning apparatus including: an expert probability label acquisition unit that calculates a probability h_{j,c} that a true label with respect to data corresponding to learning feature amount data j is a label c using a set of data to which evaluators of experts have assigned labels; a probability label acquisition unit that calculates a probability h_{j,c} that the true label with respect to the data corresponding to the learning feature amount data j is the label c using a set of data to which evaluators of experts or non-experts have assigned labels and the probability h_{j,c} calculated by the expert probability label acquisition unit; and a learning unit that regards feature amount data as input using the probability h_{j,c} calculated by the probability label acquisition unit and learning feature amount data j corresponding to the probability h_{j,c} calculated by the probability label acquisition unit and learns a model for outputting a label.

### Effects of the Invention

According to the present invention, it is possible to learn a model having higher estimation accuracy in consideration of a difference in label assignment accuracy between experts and non-experts.

### BRIEF DESCRIPTION OF DRAWINGS

FIG. 1 is a function block diagram of a model learning apparatus according to a first embodiment.

FIG. 2 is a diagram showing an example of the processing flow of the model learning apparatus according to the first embodiment.

FIG. 3 is a diagram showing an example of learning label data.

FIG. 4 is a diagram showing an example of learning feature amount data.

FIG. 5 is a function block diagram of a label estimation apparatus according to the first embodiment.

FIG. 6 is a diagram showing an example of the processing flow of the label estimation apparatus according to the first embodiment.

FIG. 7 is a diagram showing a configuration example of a computer to which the present method is applied.

### DESCRIPTION OF EMBODIMENTS

Hereinafter, an embodiment of the present invention will be described. Note that constituting units having the same functions or steps in which the same processing is performed will be denoted by the same symbols and their duplicated descriptions will be omitted in the drawings used in the following descriptions. In the following descriptions, symbols “^” or the like that will be used in texts should be originally placed right above next previous characters but placed right after the characters due to the syntax of the text. In Formulae, these symbols will be placed at their original positions. Further, processing performed in units of respective elements such as vectors and matrices will be applied to all the elements of the vector or the matrices unless otherwise specifically noted.

### Point of First Embodiment

In the present embodiment, a model is first learned using only expert labels, and then a model is further learned using the learned model, the expert labels, and non-expert labels.

### Label Estimation System According to First Embodiment

A label estimation system according to the present embodiment includes a model learning apparatus 100 and a label estimation apparatus 200.

The model learning apparatus and the label estimation apparatus are special apparatuses configured by, for example, reading a special program into a known or dedicated computer having a central arithmetic processing device (CPU: Central Processing Unit), a main storage device (RAM: Random Access Memory), or the like. The model learning apparatus and the label estimation apparatus perform, for example, respective processing under the control of the central arithmetic processing device. Data input to the model learning apparatus and the label estimation apparatus or data obtained in respective processing is stored in, for example, the main storage device, and the data stored in the main storage device is read into the central arithmetic processing device where necessary and used for other processing. The respective processing units of the model learning apparatus and the label estimation apparatus may be at least partially configured by hardware such as an integrated circuit. Respective storage units provided in the model learning apparatus and the label estimation apparatus can be configured by, for example, a main storage device such as a RAM (Random Access Memory) or middleware such as a relational database and a key-value store. However, the respective storage units are not necessarily required to be provided inside the model learning apparatus and the label estimation apparatus but may be configured by an auxiliary storage device configured by a semiconductor memory element such as a hard disk, an optical disc, and a flash memory and provided outside the model learning apparatus and the label estimation apparatus.

### Model Learning Apparatus 100 According to First Embodiment

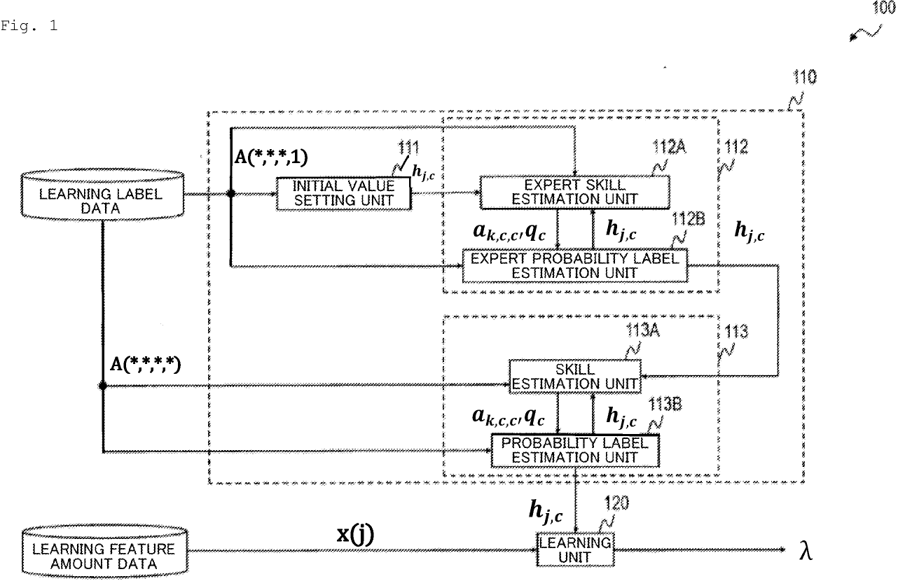

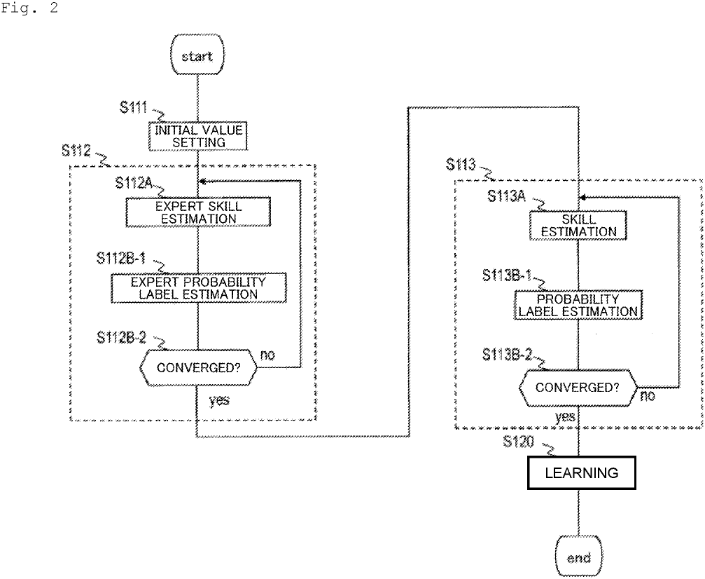

FIG. 1 shows a function block diagram of the model learning apparatus 100 according to the first embodiment, and FIG. 2 shows the processing flow thereof.

The model learning apparatus 100 includes a label estimation unit 110 and a learning unit 120. The label estimation unit 110 includes an initial value setting unit 111, an expert probability label acquisition unit 112, and a probability label acquisition unit 113. The expert probability label acquisition unit 112 includes an expert skill estimation unit 112A and an expert probability label estimation unit 112B. The probability label acquisition unit 113 includes a skill estimation unit 113A and a probability label estimation unit 113B.

The model learning apparatus 100 regards a set A of learning label data and learning feature amount data corresponding to the set A of the learning label data as input, learns a label estimation model, and outputs the learned label estimation model. In the present embodiment, the model learning apparatus 100 outputs a parameter λ of a learned label estimation model.

### Learning Label Data and Learning Feature Amount Data

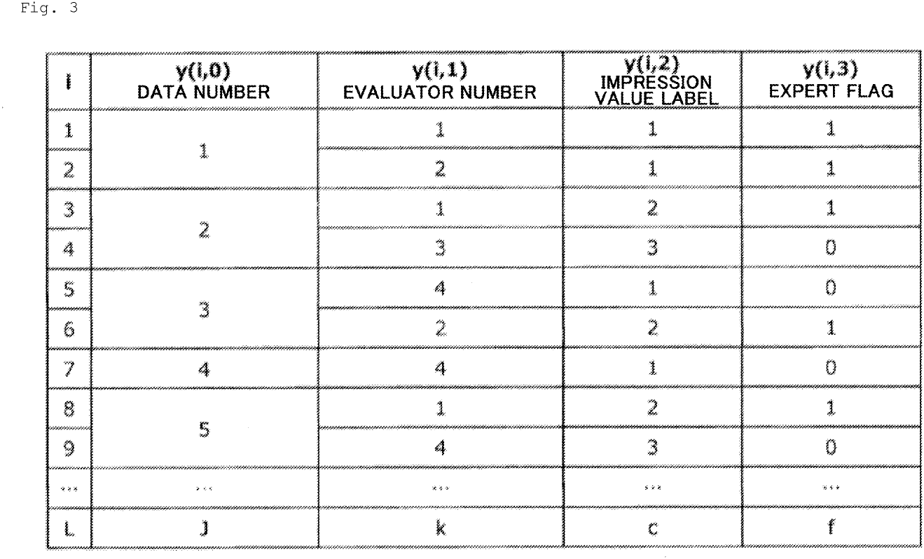

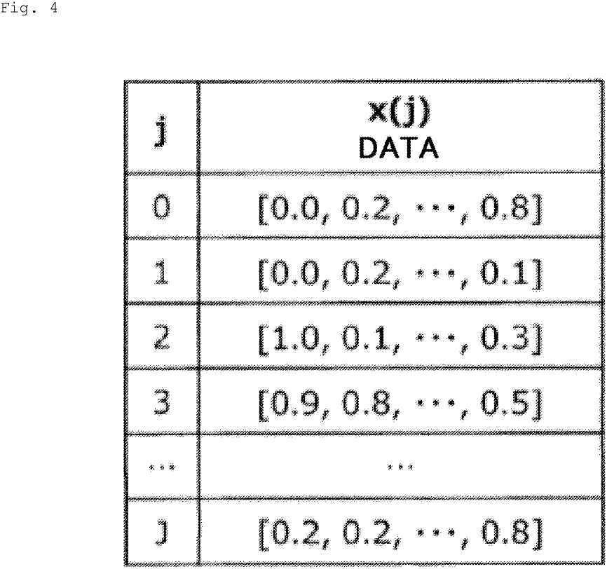

FIG. 3 shows an example of learning label data, and FIG. 4 shows an example of learning feature amount data. The learning label data includes, with respect to data numbers i (i = 1, ..., L) of the learning label data, data numbers y(i,0) of the learning feature amount data, evaluator numbers y(i,1), impression labels y(i,2), and expert flags y(i,3). The data numbers y(i,0) of the learning feature amount data represent j∈{1, ..., J}. Further, the evaluator numbers y(i,1) represent numbers k∈{1, ..., K} of evaluators who have evaluated data corresponding to the learning feature amount data. The impression value labels y(i,2) represent impression values c∈{1, ..., C} with respect to the data corresponding to the learning feature amount data. In other words, the impression value labels y(i,2) represent the impression values assigned to the data by the evaluators. The expert flags y(i,3) represent flags f∈{0,1} showing whether the evaluators (evaluators corresponding to the evaluator numbers y(i,1)) are experts. In the present embodiment, it is assumed that the evaluators y(i,1) are experts where y(i,3) is equal to 1, and the evaluators y(i,1) are non-experts where y(i,3) is equal to 0. The learning label data is assumed to be one in which one or more impression labels are assigned to data corresponding to one learning feature amount data by one or more evaluators as shown in FIG. 3. It is found from the i-th learning label data A(i) = A(j,k,c,f) that evaluators k who are experts or non-experts shown by flags f have assigned impression labels c to data corresponding to certain learning feature amount data x(j) .

The learning feature amount data represents data x (j) corresponding to data numbers j (j = 1, ..., J) . For example, the “learning feature amount data” represents the value of a vector (acoustic feature vector) or the like obtained by extracting a feature from a voice signal (see FIG. 4), and the “data corresponding to the learning feature amount data” represents a voice signal that is a source from which the learning feature amount data is extracted. Note that the learning feature amount data may be a voice signal itself, and the “learning feature amount data” may be equal to the “data corresponding to the learning feature amount data”. Hereinafter, “data corresponding to learning feature amount data x(j)” will also be simply called “learning feature amount data j”.

Hereinafter, the respective units will be described.

### Label Estimation Unit 110

The label estimation unit 110 regards a set A of learning label data as input, calculates ability with which evaluators can properly make an evaluation and a probability h_{j,c} of a true label based on the ability (S110), and outputs the calculated ability and the probability h_{j,c}. Note that the probability h_{j,c} represents a probability that the true label of learning feature amount data j (j = 1, ..., J) is a label c (c = 1, ..., C) .

Here, it is assumed that impression labels assigned to the learning label data include a true label cⱼ with respect to the learning feature amount data j. Further, a probability a_{k,c,c}′ that evaluators k properly answer c′ when the ability to assign labels is different for each evaluator and the true label is c is introduced.

The label estimation unit 110 estimates a true label and the ability of evaluators with an EM algorithm and outputs a probability h_{j,c} of an optimum label to the learning unit 120. Here, sets A for retrieving the learning label data of data numbers j, evaluator numbers k, impression labels c, and expert flags f and N showing the number of the data are defined as follows.

$$A \left(j , k , c , f\right) = \left\{\left(i\right| y \left(i , 0\right) = j ∧ y \left(i , 1\right) = k ∧ y \left(i , 2\right) = c ∧ y \left(i , 3\right) = f , ∀ i \text{}\right\} ,$$

$$N \left(j , k , c , f\right) = \left|A \left(j , k , c , f\right)\right|$$

$$A \left(∗ , k , c , f\right) = \left\{\left(i\right| y \left(i , 1\right) = k ∧ y \left(i , 2\right) = c ∧ y \left(i , 3\right) = f , ∀ i \text{}\right\} ,$$

$$N \left(∗ , k , c , f\right) = \left|A \left(∗ , k , c , f\right)\right|$$

$$A \left(j , ∗ , c , f\right) = \left\{\left(i\right| y \left(i , 0\right) = j ∧ y \left(i , 2\right) = c ∧ y \left(i , 3\right) = f , ∀ i \text{}\right\} ,$$

$$N \left(j , ∗ , c , f\right) = \left|A \left(j , ∗ , c , f\right)\right|$$

$$A \left(j , k , ∗ , f\right) = \left\{\left(i\right| y \left(i , 0\right) = j ∧ y \left(i , 1\right) = k ∧ y \left(i , 3\right) = f , ∀ i \text{}\right\} ,$$

$$N \left(j , k , ∗ , f\right) = \left|A \left(j , k , ∗ , f\right)\right|$$

$$A \left(j , ∗ , ∗ , f\right) = \left\{\left(i\right| y \left(i , 0\right) = j ∧ y \left(i , 3\right) = f , ∀ i \text{}\right\} ,$$

$$N \left(j , ∗ , ∗ , f\right) = \left|A \left(j , ∗ , ∗ , f\right)\right|$$

$$A \left(∗ , k , ∗ , f\right) = \left\{\left(i\right| y \left(i , 1\right) = k ∧ y \left(i , 3\right) = f , ∀ i \text{}\right\} ,$$

$$N \left(∗ , k , ∗ , f\right) = \left|A \left(∗ , k , ∗ , f\right)\right|$$

$$A \left(∗ , ∗ , c , f\right) = \left\{\left(i\right| y \left(i , 2\right) = c ∧ y \left(i , 3\right) = f , ∀ i \text{}\right\} ,$$

$$N \left(∗ , ∗ , c , f\right) = \left|A \left(∗ , ∗ , c , f\right)\right|$$

$$A \left(∗ , ∗ , ∗ , f\right) = \left\{\left(i\right| y \left(i , 3\right) = f , ∀ i \text{}\right\} ,$$

$$N \left(∗ , ∗ , ∗ , f\right) = \left|A \left(∗ , ∗ , ∗ , f\right)\right|$$

$$A \left(j , k , c , ∗\right) = \left\{\left(i\right| y \left(i , 0\right) = j ∧ y \left(i , 1\right) = k ∧ y \left(i , 2\right) = c , ∀ i \text{}\right\} ,$$

$$N \left(j , k , c , ∗\right) = \left|A \left(j , k , c , ∗\right)\right|$$

$$A \left(∗ , k , c , ∗\right) = \left\{\left(i\right| y \left(i , 1\right) = k ∧ y \left(i , 2\right) = c , ∀ i \text{}\right\} ,$$

$$N \left(∗ , k , c , ∗\right) = \left|A \left(∗ , k , c , ∗\right)\right|$$

$$A \left(j , ∗ , c , ∗\right) = \left\{\left(i\right| y \left(i , 0\right) = j ∧ y \left(i , 2\right) = c , ∀ i \text{}\right\} ,$$

$$N \left(j , ∗ , c , ∗\right) = \left|A \left(j , ∗ , c , ∗\right)\right|$$

$$A \left(j , k , ∗ , ∗\right) = \left\{\left(i\right| y \left(i , 0\right) = j ∧ y \left(i , 1\right) = k , ∀ i \text{}\right\} ,$$

$$N \left(j , k , ∗ , ∗\right) = \left|A \left(j , k , ∗ , ∗\right)\right|$$

$$A \left(j , ∗ , ∗ , ∗\right) = \left\{\left(i\right| y \left(i , 0\right) = j , ∀ i \text{}\right\} ,$$

$$N \left(j , ∗ , ∗ , ∗\right) = \left|A \left(j , ∗ , ∗ , ∗\right)\right|$$

$$A \left(∗ , k , ∗ , ∗\right) = \left\{\left(i\right| y \left(i , 1\right) = k , ∀ i \text{}\right\} ,$$

$$N \left(∗ , k , ∗ , ∗\right) = \left|A \left(∗ , k , ∗ , ∗\right)\right|$$

$$A \left(∗ , ∗ , c , ∗\right) = \left\{\left(i\right| y \left(i , 2\right) = c , ∀ i \text{}\right\} ,$$

$$N \left(∗ , ∗ , c , ∗\right) = \left|A \left(∗ , ∗ , c , ∗\right)\right|$$

$$A = A \left(∗ , ∗ , ∗ , ∗\right) = \left\{∀ i \text{}\right\} ,$$

$$N = N \left(∗ , ∗ , ∗ , ∗\right) = \left|A \left(∗ , ∗ , ∗ , ∗\right)\right| = I$$

Note that * is a symbol where any data is input.

In the present embodiment, a probability h_{j,c} is calculated in advance by a set A(*,*,*,1) of the learning label data of experts (a set of data to which the evaluators of the experts have assigned labels), whereby a probability a_{k,c,c}′ corresponding to the skills of non-experts is evaluated on the basis of the set A(*,*,*,1) of the learning label data of the experts. Therefore, a probability h_{j,c} of a set A(*,*,*,*) (a set of data to which the evaluators of experts or non-experts have assigned labels) of all the learning label data can be calculated on the basis of the criteria of the experts.

Note that the label estimation unit 110 ends model learning when prescribed conditions are satisfied. For example, the label estimation unit 110 ends the model learning when a difference in the probability h_{j,c} before and after an update falls below a previously-set threshold δ in all the feature amount data j and impression labels c.

### Initial Value Setting Unit 111

The initial value setting unit 111 regards a set of data to which evaluators k of experts f = 1 have assigned labels (a set A(*,*,*,1) of the learning label data of the experts) as input, sets the initial value of a probability h_{j,c} that a true label with respect to learning feature amount data j is a label c using the set of the data (S111), and outputs the set initial value.

For example, the initial value setting unit 111 sets the initial value of the EM algorithm of a probability h_{j,c} that a true label is a label c as follows with respect to all the labels c (c = 1, ..., C) of data j (j = 1, ..., J) assigned by evaluators k of experts f = 1.

$${h}_{j , c} = \frac{N \left(j , ∗ , c , 1\right)}{N \left(j , ∗ , ∗ , 1\right)}$$

The probability h_{j,c} represents a probability value at which learning feature amount data j is a label c.

### Expert Probability Label Acquisition Unit 112

The expert probability label acquisition unit 112 regards a set A(*,*,*,1) of the learning label data of experts and the initial value of a probability h_{j,c} as input, calculates a probability h_{j,c} that a true label with respect to learning feature amount data j is a label C with an EM algorithm using these values (S112), and outputs the calculated probability h_{j,c}.

Hereinafter, processing (processing corresponding to the M step of the EM algorithm) in the expert skill estimation unit 112A and processing (processing corresponding to the E step of the EM algorithm) in the expert probability label estimation unit 112B that are included in the expert probability label acquisition unit 112 will be described.

### Expert Skill Estimation Unit 112A

The expert skill estimation unit 112A regards a set A(*,*,*,1) of the learning label data of experts and the initial value of a probability h_{j,c} or a probability h_{j,c} calculated in the previous repetitive processing of the EM algorithm as input. Then, the expert skill estimation unit 112A calculates a probability a_{k,c,c}′ that evaluators k of experts f = 1 answer a label c′ where a true label with respect to learning feature amount data is c and a distribution q_{c} of respective labels c for all the labels 1, ..., C using these values (S112A) and outputs the calculated probability a_{k,c,c}′ and the distribution q_{c}. For example, the expert skill estimation unit 112A calculates the probability a_{k,c,c}′ and the distribution q_{c} according to the following Formulae.

$${a}_{k , c , {c}^{′}} = \frac{\sum {}_{i ∈ A \left(∗ , k , {c}^{′} , 1\right)} {h}_{y \left(i .0\right) , c}}{\sum {}_{i ∈ A \left(∗ , k . ∗ , 1\right)} {h}_{y \left(i , 0\right) , c}}$$

$${q}_{c} = \frac{\sum {}_{i ∈ A \left(∗ , ∗ , c , 1\right)} {h}_{y \left(i , 0\right) , c}}{N}$$

### Expert Probability Label Estimation Unit 112B

The expert probability label estimation unit 112B regards a set A(*,*,*,1) of the learning label data of experts and a probability a_{k,c,c}′ and a distribution q_{c} calculated by the expert skill estimation unit 112A as input, calculates a value Q_{j,c} for each learning feature amount data j and label c using these values, updates a probability h_{j,c} using the calculated values Q_{j,c} (S112B-1), and outputs the updated probability h_{j,c}. For example, the expert probability label estimation unit 112B calculates the values Q_{j,c} and the probability h_{j,c} according to the following Formulae.

$${Q}_{j , c} = {q}_{c} {\prod }_{i ∈ A \left(j , ∗ , c , 1\right)} {a}_{y \left(i , 1\right) , c , y \left(i , 2\right)}$$

$${h}_{j , c} = \frac{{Q}_{j , c}}{\sum {}_{{c}^{′}} {Q}_{j , {c}^{′}}}$$

The expert probability label estimation unit 112B determines whether the value of the probability h_{j,c} has converged (S112B-2). When the value of the probability h_{j,c} has converged (yes in S112B-2), the expert probability label estimation unit 112B ends the update processing and outputs a probability h_{j,c} at an end point. When the value of the probability h_{j,c} has not converged (no in S112B-2), the expert probability label estimation unit 112B outputs a probability h_{j,c} after the update and a control signal showing the repetition of the processing to the expert skill estimation unit 112A. For example, when a difference in the probability h_{j,c} before and after the update is smaller than a prescribed threshold 5 in all learning feature amount data j and label labels c or is the prescribed threshold 5 or less, the expert probability label estimation unit 112B determines that the value of the probability h_{j,c} has converged. Otherwise, the expert probability label estimation unit 112B determines that the value of the probability h_{j,c} has not converged. Further, for example, when the number of the times of the repetitive processing becomes greater than a prescribed number of times, the expert probability label estimation unit 112B determines that the value of the probability h_{j,c} has converged. Otherwise, the expert probability label estimation unit 112B determines that the value of the probability h_{j,c} has not converged.

### Probability Label Acquisition Unit 113

The probability label acquisition unit 113 regards a set A(*,*,*,*) of data to which the evaluators of experts or non-experts have assigned labels and a probability h_{j,c} calculated by the expert probability label acquisition unit 112 as input, calculates a probability h_{j,c} that a true label with respect to learning feature amount data j is a label c with an EM algorithm using these values (S113), and outputs the calculated probability h_{j,c}.

Hereinafter, processing (processing corresponding to the M step of the EM algorithm) in the skill estimation unit 113A and processing (processing corresponding to the E step of the EM algorithm) in the probability label estimation unit 113B that are included in the probability label acquisition unit 113 will be described.

### Skill Estimation Unit 113A

The skill estimation unit 113A regards a set A(*,*,*,*) of data to which the evaluators of experts or non-experts have assigned labels and a probability h_{j,c} calculated by the expert probability label acquisition unit 112 or the previous repetitive processing of the EM algorithm as input. Then, the skill estimation unit 113A calculates a probability a_{k,c,c′} that evaluators k of experts or non-experts answer a label c′ where a true label with respect to learning feature amount data is c and a distribution q_{c} of respective labels c for all the labels 1, ..., C using these values (S113A) and outputs the calculated probability a_{k,c,c}′ and the distribution q_{c}. For example, the skill estimation unit 113A calculates the probability a_{k,c,c}′ and the distribution q_{c} according to the following Formulae.

$${a}_{k , c , {c}^{′}} = \frac{\sum {}_{i ∈ A \left(∗ , k , {c}^{′} , ∗\right)} {h}_{y \left(i , 0\right) , c}}{\sum {}_{i ∈ A \left(∗ , k . ∗ , ∗\right)} {h}_{y \left(i , 0\right) , c}}$$

$${q}_{c} = \frac{\sum {}_{i ∈ A \left(∗ , ∗ , c , ∗\right)} {h}_{y \left(i , 0\right) , c}}{N}$$

### Probability Label Estimation Unit 113B

The probability label estimation unit 113B regards a set A(*,*,*,*) of data to which the evaluators of experts or non-experts have assigned labels and a probability a_{k,c,c}′ and a distribution q_{c} calculated by the skill estimation unit 113A as input, calculates a value Q_{j,c} for each learning feature amount data j and label c using these values, updates a probability h_{j,c} using the values Q_{j,c} (S113B-1), and outputs the updated probability h_{j,c}. For example, the probability label estimation unit 113B calculates the values Q_{j,c} and the probability h_{j,c} according to the following Formulae.

$${Q}_{j , c} = {q}_{c} {\prod }_{i ∈ A \left(j , ∗ , c , ∗\right)} {a}_{y \left(i , 1\right) , c , y \left(i , 2\right)}$$

$${h}_{j , c} = \frac{{Q}_{j , c}}{\sum {}_{{c}^{′}} {Q}_{j , {c}^{′}}}$$

The probability label estimation unit 113B determines whether the value of the probability h_{j,c} has converged (S113B-2). When the value of the probability h_{j,c} has converged (yes in S113B-2), the probability label estimation unit 113B ends the update processing and outputs a probability h_{j,c} at an end point. When the value of the probability h_{j,c} has not converged (no in S113B-2), the probability label estimation unit 113B outputs a probability h_{j,c} after the update and a control signal showing the repetition of the processing to the skill estimation unit 113A. A determination method is, for example, the same as that described in the section of the expert probability label estimation unit 112B.

### Learning Unit 120

The learning unit 120 regards a probability h_{j,c} calculated by the probability label acquisition unit 113 and learning feature amount data x(j) corresponding to the probability h_{j,c} calculated by the probability label acquisition unit 113 as input, regards feature amount data as input using these values, learns a model for outputting labels (S120), and outputs the learned label estimation model.

In the present embodiment, the learning unit 120 targets at a probability h_{j,c} calculated by the probability label acquisition unit 113 to learn a label estimation model.

For example, when a model is a neural network, an error may be provided as follows to perform learning so as to minimize a cross-entropy error.

$$E = - {\sum }_{j} {\sum }_{c} {h}_{j , c} log \hat{y} \left(j\right)$$

Here, y^(j) represents an estimated value y^(j) = f(x(j)) of a neural network model. At this time, the learning unit 120 updates a parameter λ of a model f so as to minimize an error function E.

Further, when performing learning with a SVM, the learning unit 120 may, for example, increase learning data by the number of labels c with respect to the same data x(j) and weigh respective sample weights h_{j,c}.

For example, the learning unit 120 outputs a parameter λ of a learned label estimation model f.

Next, the label estimation apparatus 200 will be described.

### Label Estimation Apparatus 200 According to First Embodiment

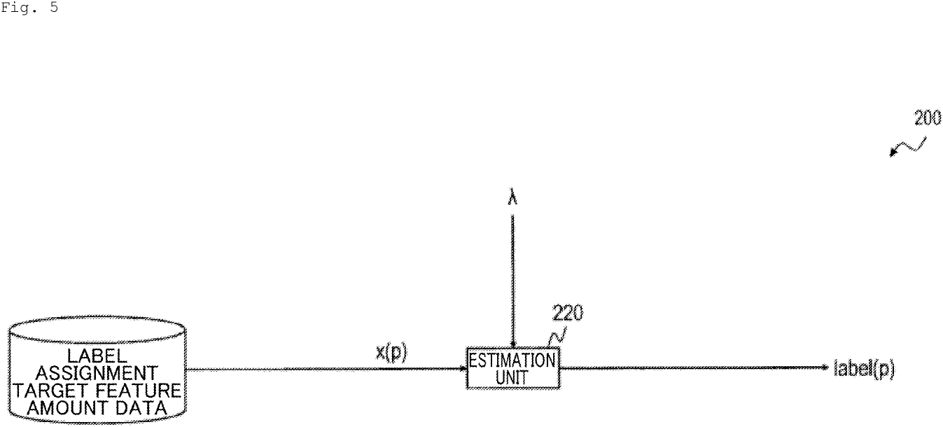

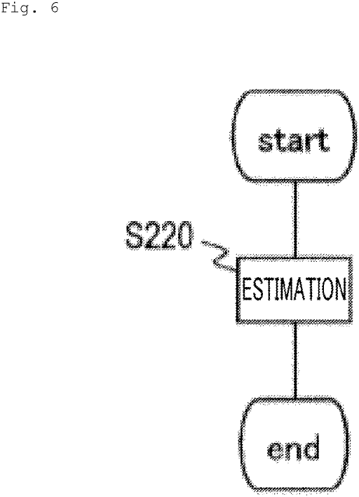

FIG. 5 shows a function block diagram of the label estimation apparatus 200 according to the first embodiment, and FIG. 6 shows the processing flow thereof.

The label estimation apparatus 200 includes an estimation unit 220.

The estimation unit 220 of the label estimation apparatus 200 receives a parameter λ of a learned label estimation model f in advance prior to label estimation processing.

The estimation unit 220 of the label estimation apparatus 200 regards label assignment target feature amount data x(p) as input, estimates a label with respect to label assignment target data using a learned parameter λ and a label estimation model f (S220), and outputs an estimation result label(p). Note that the label assignment target data represents data serving as a source from which label assignment target feature amount data is extracted.

### Effect

The model learning apparatus according to the present embodiment can learn a model having higher estimation accuracy in consideration of a difference in label assignment accuracy between experts and non-experts. By using the model, the label estimation apparatus according to the present embodiment can accurately estimate labels.

### Modified Example

In the present embodiment, learning feature amount data and label assignment target feature amount data are regarded as input. However, data from which these feature amounts are extracted may be regarded as input. In this case, a feature amount extraction unit having the function of extracting the feature amounts from the data may be provided.

The present embodiment shows impression labels as an example but is applicable to other labels so long as evaluators who assign labels can be divided into experts and non-experts.

### Other Modified Examples

The present invention is not limited to the above embodiment and the modified example. For example, the above-described various processing is performed in chronological order as described but may be performed in parallel or separately according to the processing performance of an apparatus that performs the processing or where necessary. Besides, the processing is appropriately modifiable without departing from the scope of the present invention.

### Program and Recording Medium

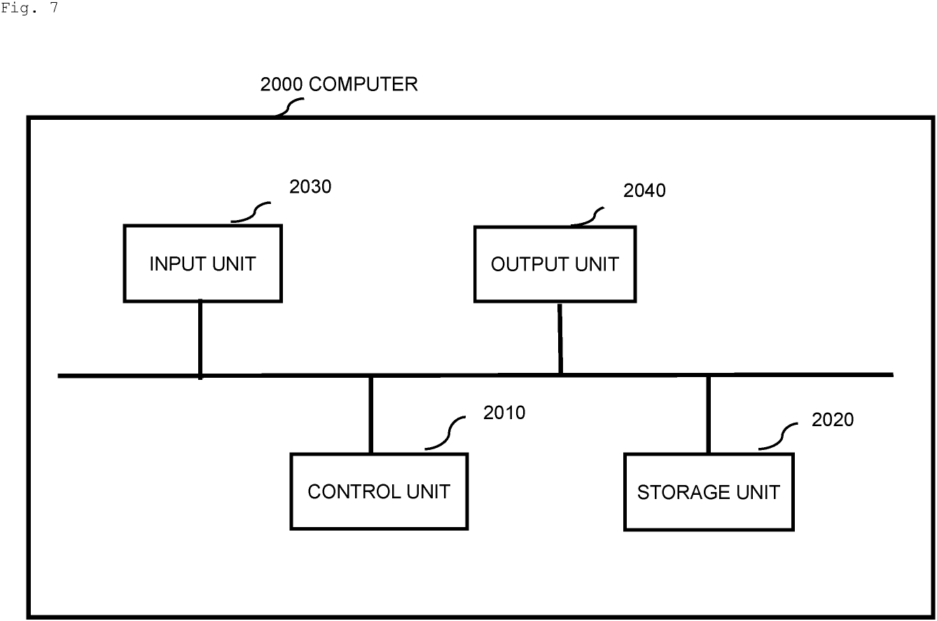

The above-described various processing can be performed by causing a storage unit 2020 of a computer shown in FIG. 7 to read a program for performing the respective steps of the above method and causing a control unit 2010, an input unit 2030, an output unit 2040, or the like to operate.

The program in which processing contents are described can be recorded in advance on a computer-readable recording medium. As a computer-readable recording medium, any medium such as a magnetic recording device, an optical disc, a magneto-optical recording medium, and a semiconductor memory may be, for example, used.

Further, the circulation of the program is performed by, for example, selling, releasing, lending, or the like of a transportable recording medium such as a DVD and a CD-ROM on which the program is recorded. In addition, the circulation of the program may be performed by storing the program in advance in the storage device of a server computer and transferring the program from the server computer to another computer via a network.

For example, a computer that performs such a program first temporarily stores a program recorded on a transportable recording medium or a program transferred from a server computer in an own storage device. Then, when performing processing, the computer reads the program stored in the own recording medium and performs the processing according to the read program. Further, as another mode for performing the program, the computer may directly read the program from a transportable recording medium and perform processing according to the program. In addition, the computer may perform processing according to the received program every time the program is transferred from the server computer to the computer. Further, the above-described processing may be performed by a so-called ASP (Application Service Provider) service in which the program is not transferred from the server computer to the computer but a processing function is realized only by an instruction for performing the program and the acquisition of a result. Note that the program according to the present embodiment includes one that is information subjected to processing by an electronic calculator and complies with the program (such as data that is not a direct instruction to a computer but has properties defining the processing of the computer).

Further, a prescribed program is performed on a computer to configure the present apparatus in the embodiment, but at least a part of the processing contents may be realized by hardware.

1. A model learning apparatus in which learning label data includes, with respect to a first set of first data numbers, a second set of second data numbers showing third data numbers of learning feature amount data, evaluator numbers showing fourth numbers of evaluators who have assigned labels to data corresponding to the learning feature amount data, labels showing labels assigned to the data corresponding to the learning feature amount data, and expert flags representing flags showing whether the evaluators are experts who assign labels to the data corresponding to the learning feature amount data, the model learning apparatus comprising a processor configured to execute a method comprising:
calculating a first probability that a true label with respect to data corresponding to learning feature amount data is a label using a set of data to which evaluators of experts have assigned labels;
calculating a second probability that the true label with respect to the data corresponding to the learning feature amount data is the label using a set of data to which evaluators including at least one of either experts or non-experts have assigned labels and the first probability ;
determining afeature amount data as input using the second probability; and
learning, based on the feature amount data corresponding to the second probability
a model for outputting a label.

2. The model learning apparatus according to claim 1, the processor further configured to execute a method comprising:
the calculating the first probability further comprises:
calculating a third probability that an expert as an evaluator answers a labelwhere a true label with respect to data corresponding to learning feature amount data includes the label and a distribution of respective labels for a plurality of labels
calculating a value for each learning feature amount data and the label using the probability and the distribution and
updating the second probability h_{j,c} using the values associated with the learning feature amount data; and
the calculating the second probability further comprises:
calculating a fourth probability that an evaluator including either an expert or a non-expert answers the label where a true label with respect to data corresponding to learning feature amount data is c and a distribution q_{c} of respective labelsfora plurality of labels; and
calculating a the value for each learning feature amount dataand the labelusing the fourth probability and the distribution; and updating the probability using the values.

3. The model learning apparatus according to claim 1, comprising:
Setting an initial value ofthe first probability that a true label with respect to data corresponding to learning feature amount data is the label using a set of data to which evaluators of experts have assigned labels.

4. A model learning method using a model learning apparatus in which learning label data includes, with respect to a first set of first data numbers, a second set of second data numbers showing third data numbers of learning feature amount data, evaluator numbers showing fourth numbers of evaluators who have assigned labels to data corresponding to the learning feature amount data, labels showing labels assigned to the data corresponding to the learning feature amount data, and expert flagsrepresenting flags showing whether the evaluators are experts who assign labels to the data corresponding to the learning feature amount data, the model learning method comprising:
calculating a first probability that a true label with respect to data corresponding to learning feature amount data is a label using a set of data to which evaluators of experts have assigned labels;
a calculating a second probability that the true label with respect to the data corresponding to the learning feature amount data is the label using a set of data to which evaluatorsincluding at least one of either experts or non-experts have assigned labels and the first probability;
determining a feature amount data as input using the second probability; and
learning, based on the feature amount data corresponding to the second probability a model for outputting a label.

5. A computer-readable non-transitory recording medium storing computer-executable program instructions that when executed by a processor cause a computer to execute a method comprising:
calculating a first probability that a true label with respect to data corresponding to learning feature amount data is a label using a set of data to which experts as evaluators have assigned the label;
calculating a second probability that the true label with respect to the data corresponding to the learning feature amount data is the label using a set of data to which evaluators including a non-expert have assigned labels and the first probability;
determining feature amount data as input using the second probability; and
learning, based on the feature amount data corresponding to the second probability a model for outputting a label.

6. The computer-readable non-transitory recording medium according to claim 5, wherein the learning feature amount data include:
with respect to a first set of first data numbers:
a second set of second data numbers showing third data numbers of learning feature amount data,
evaluator numbers showing fourth numbers of evaluators who have assigned labels to data corresponding to the learning feature amount data, labels showing labels assigned to the data corresponding to the learning feature amount data, and
expert flags representing flags showing whether the evaluators are experts who assign labels to the data corresponding to the learning feature amount data.
